(19) United States
(12) Patent Application Publication
(10) Pub. No.: US 2025/0027429 A1
(43) Pub. Date: Jan. 23, 2025

(54) AIR-OIL HEAT EXCHANGER

(71) Applicant: SAFRAN AERO BOOSTERS SA, Herstal (BE)

(72) Inventors: David WEICKER, Rhode-Saint-Genèse (BE); Florian CLEYET, Rhode-Saint-Genèse (BE); Bruno SERVAIS, Herstal (BE)

(21) Appl. No.: 18/714,247

(22) PCT Filed: Nov. 30, 2022
(86) PCT No.: PCT/EP2022/083838

§ 371 Date: May 29, 2024

(30) Foreign Application Priority Data
Nov. 30, 2021 (EP) 21211471.4
Dec. 14, 2021 (BE) BE2021/5983

(51) Int. Cl. F01D 25/12

(52) U.S. Cl. CPC F01D 25/12; F05D 2260/213

(57) ABSTRACT

A heat exchanger of the air/oil type, for an annular air stream of a turbomachine, comprising a heat exchange zone with oil passages and heat exchange surfaces with the air, said heat exchange zone forming an axial air passage and having a profile facing the air flow and included in a plane perpendicular to said air flow, said profile of the exchange zone thermal being in an arc of a circle so as to be able to be arranged in the annular air stream, remarkable in that said heat exchanger comprises on a radially internal or external face of the exchange zone thermal, an oil inlet and an oil outlet, the oil passages comprising several paths between said oil inlet and said oil outlet, distributed along the profile in circular arc of the heat exchange zone.

### DOMAIN

The invention relates to the field of turbomachine heat exchangers. More precisely, the invention proposes an axial turbomachine air/oil heat exchanger.

### PRIOR ART

In a turbomachine (turbojet), it is generally necessary to cool the oil in the lubrication circuit. For this purpose, it is known to place one or more heat exchanger(s) in the secondary flow, that is to say downstream of the fan.

However, the provision of a heat exchanger at the secondary circuit penalizes the performance and overall efficiency of the turbomachine. In fact, the thrust force generated by the fan is partly slowed down by the bulky exchanger. In addition, aerodynamic disturbances in the secondary flow may occur, leading to vibrations and noise pollution.

The published patent document EP 3 674 531 A1 discloses an air-oil type heat exchanger placed in the vein of the secondary flow of a turbomachine. Such a heat exchanger generates significant disturbances to the secondary flow having a speed too high for the aerodynamic or thrust losses to be negligible.

Published patent document U.S. Pat. No. 10,502,502 A1 discloses a heat exchanger obtained by additive manufacturing and comprising smaller fluid passages.

The state of the art therefore presents disadvantages relating to performance penalties. To which is added the constraint linked to the fragility of the exchanger.

In fact, it cannot be placed in a tertiary flow vein comprised radially between the primary flow and the secondary flow. However, the risk of debris and foreign bodies passing into the tertiary flow vein is high, which can damage the heat exchanger.

### SUMMARY OF THE INVENTION

### Technical Problem

The invention aims to propose a heat exchanger which minimizes the aerodynamic losses induced by the presence of the exchanger in the air flow vein. Also, the invention also aims to improve heat exchange in order to guarantee effective cooling in a restricted space without hindering the efficiency of the turbomachine.

### Technical Solution

The invention relates to a heat exchanger of the air/oil type, for an annular air stream of a turbomachine, comprising a heat exchange zone with oil passages and heat exchange surfaces with the air, said heat exchange zone forming an axial air passage and having a profile facing the air flow and included in a plane perpendicular to said air flow, said profile of the heat exchange zone being in an arc of a circle so as to be able to be arranged in the annular air stream, remarkable in that said heat exchanger comprises on a radially internal or external face of the heat exchange zone, an oil inlet and an outlet oil, the oil passages comprising several paths between said oil inlet and said oil outlet, distributed along the arcuate profile of the heat exchange zone.

According to an advantageous embodiment of the invention, each of the paths comprises at least one forward portion and at least one return portion, extending radially between the radially internal face and the radially external face of the heat exchange zone.

According to an advantageous mode of the invention, each outward portion and each return portion of each of the paths are offset along the arcuate profile. of the heat exchange zone.

According to an advantageous embodiment of the invention, each of the paths comprises at least one connection portion connecting the at least one forward portion to the at least one return portion and arranged in the heat exchange zone.

According to an advantageous embodiment of the invention, each of the outward, return and connection portions of each of the paths extend over a total axial length of the heat exchange zone.

According to an advantageous embodiment of the invention, each path comprises several parallel oil passages distributed over the total axial length of the heat exchange zone.

According to an advantageous embodiment of the invention, each outward portion and each return portion of each of the paths comprises several parallel oil passages forming a doubly bent flow profile with a first radial part, a second axial part and a third radial part.

According to an advantageous embodiment of the invention, the at least one connection portion interconnects the first or third radial parts adjacent to said connection portion.

According to an advantageous embodiment of the invention, the second axial parts of the forward and return portions have opposite flow directions.

According to an advantageous embodiment of the invention, the heat exchanger comprises on the radially internal face or the radially external face of the heat exchange zone comprising the oil inlet and the oil outlet, in addition, a distributor fluidly disposed between the oil inlet and the paths and extending along the arcuate profile, and a manifold fluidly disposed between the paths and the oil outlet and extending along of the arcuate profile.

According to an advantageous embodiment of the invention, the oil inlet is at one end of the distributor following the arcuate profile and said distributor has a passage section transverse to said arcuate profile which gradually decreases along said profile in an arc from the oil inlet to an opposite end of said distributor.

According to an advantageous embodiment of the invention, the oil outlet is at one end of the collector following the arcuate profile and said collector has a passage section transverse to said arcuate profile which gradually decreases along said arcuate profile. circular arc from the oil outlet to an opposite end of said collector.

According to an advantageous embodiment of the invention, the distributor and the collector are side by side along an axial extent of the radially internal or external face of the heat exchange zone comprising the oil inlet and the oil outlet. oil.

According to an advantageous embodiment of the invention, the total radial height of the heat exchange zone increases from upstream to forward, and the axial air passage comprises air channels delimited by the heat exchange surfaces and having passage sections increasing from upstream to downstream in correspondence with the total radial height of the heat exchange zone.

According to an advantageous embodiment of the invention, the total radial height of the heat exchange zone and/or the sections of the air channels increase from upstream to downstream over at least 70% of a total axial extent of said zone. heat exchange.

According to an advantageous embodiment of the invention, the increase in the total radial height of the heat exchange zone and/or the increase in the sections of the air channels is monotonic and/or at least 30%.

According to an advantageous embodiment of the invention, the sections of the air channels have a polygonal shape, preferably hexagonal.

According to an advantageous embodiment of the invention, the heat exchange zone comprises radial walls distributed along the arcuate profile, and comprising the oil passages, the heat exchange surfaces being formed by transverse walls s extending between the radial walls.

According to an advantageous embodiment of the invention, the air channels between each pair of neighboring radial walls form at least two radial rows of polygons, preferably hexagons, nested.

According to an advantageous embodiment of the invention, the transverse walls are integrally formed with the forward portions or with the return portions.

According to an advantageous embodiment of the invention, the heat exchanger further comprises a wall with an arcuate profile parallel to, and radially at a distance from the heat exchange zone so as to form, between said wall and said heat exchange zone, a by-pass passage for air, parallel to the heat exchange passage.

According to an advantageous embodiment of the invention, the by-pass passage, outside the radial and/or lateral limits of said by-pass passage, is free of material.

According to an advantageous embodiment of the invention, the by-pass passage has a section extending along the arc of a circle with a preferably constant radial height.

According to an advantageous embodiment of the invention, the by-pass passage extends radially over a height of between 10% and 20% of a cumulative radial height of said by-pass passage and of the heat exchange zone.

According to an advantageous embodiment of the invention, the by-pass passage extends over a total extent of the heat exchanger following an air flow direction.

### Advantages of the Invention

The invention is particularly advantageous in that it makes it possible to guarantee effective heat exchange in a reduced footprint while avoiding hindering the efficiency of the engine, which results in energy efficiency and optimized thrust which advantageously makes it possible to reduce the carbon dioxide emissions.

### DESCRIPTION OF THE DESIGNS

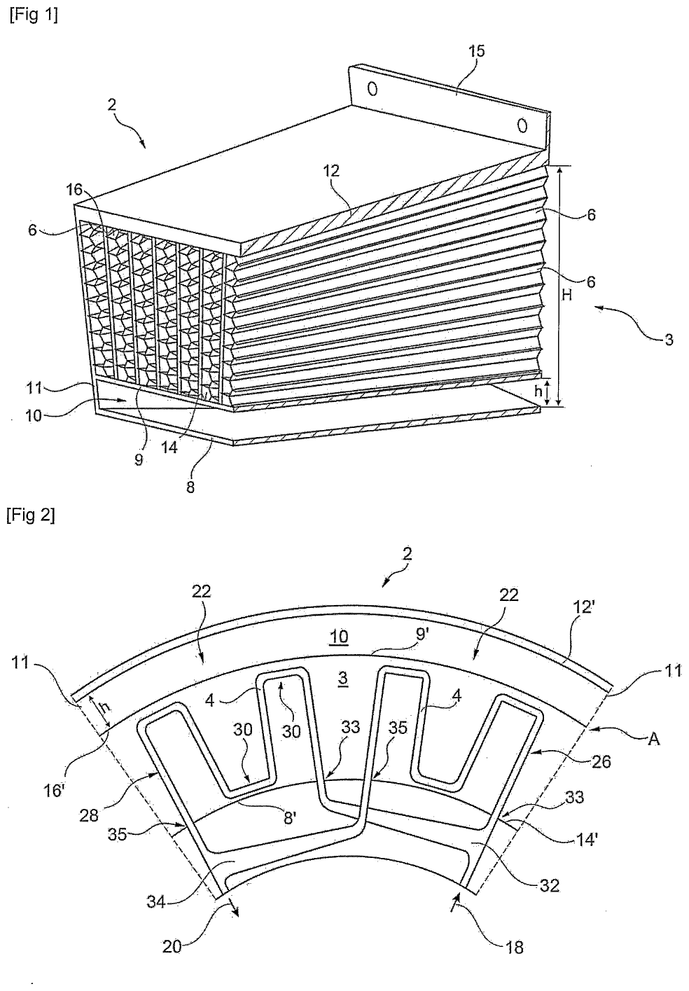

FIG. 1 is a partial perspective view of the exchanger according to a first embodiment;

FIG. 2 illustrates a sectional view of the exchanger according to a second embodiment;

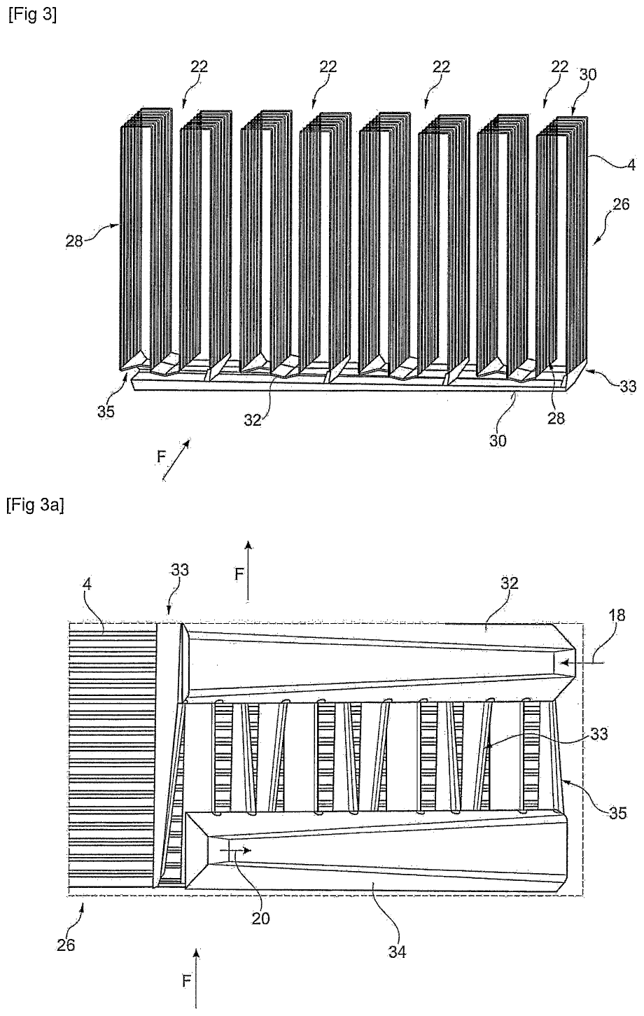

FIG. 3 represents oil paths in the exchanger according to a third embodiment;

FIG. 3a illustrates a bottom perspective view of the oil paths according to the third embodiment;

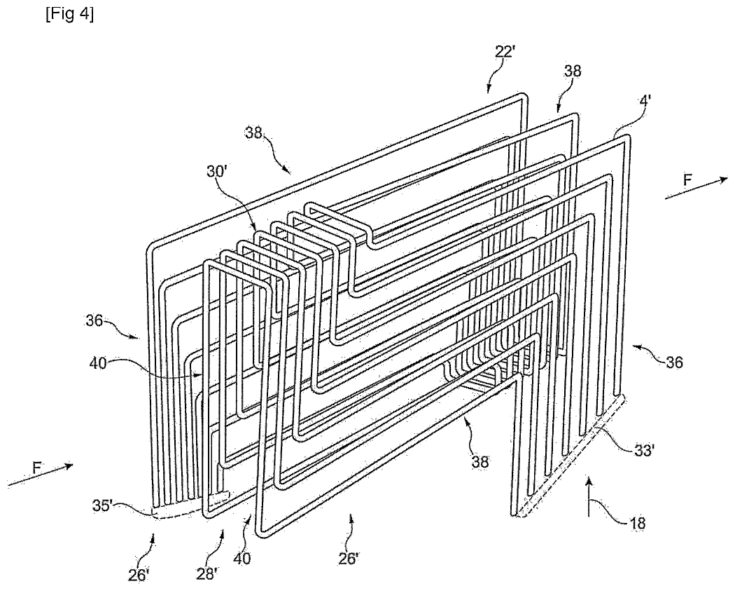

FIG. 4 represents an oil path in the exchanger according to a fourth embodiment;

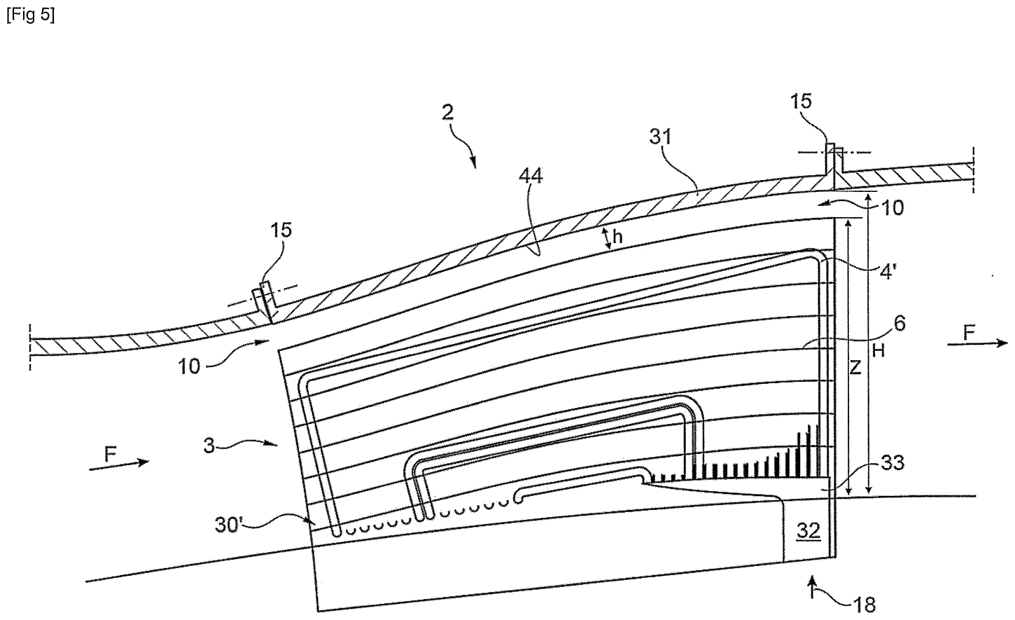

FIG. 5 illustrates a sectional view of the exchanger arranged in the annular air stream and according to the second embodiment;

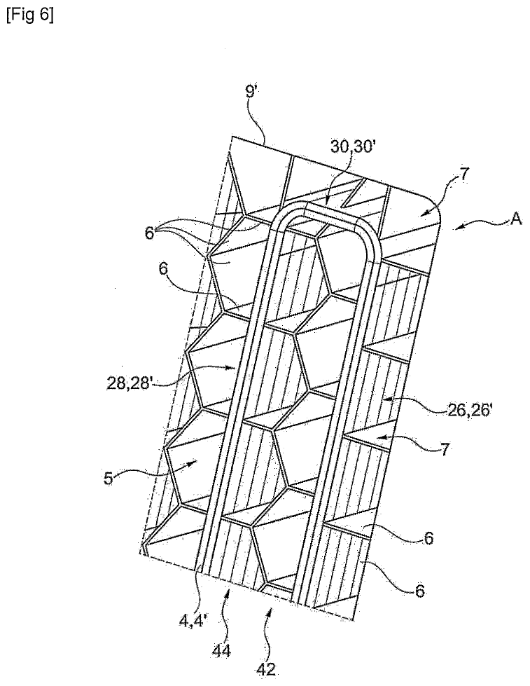

FIG. 6 represents an enlarged portion “A” of the heat exchange zone in FIG. 2.

### DESCRIPTION OF AN EMBODIMENT

In the description which follows, the terms “internal” and “external” refer to positioning relative to the axis of rotation of a turbomachine. The axial direction corresponds to the direction along the axis of rotation of the turbomachine. The radial direction is perpendicular to the axis of rotation. Upstream and downstream refer to the direction of flow of a flow in the turbomachine.

The figures show the elements schematically and are not represented to scale. In particular, certain dimensions are enlarged to facilitate reading of the figures.

FIG. 1 illustrates a partial perspective view of a heat exchanger 2 according to a first embodiment. It should be noted that a perspective view of the heat exchanger 2 is supposed to have an arcuate profile, however FIG. 1 has been greatly simplified in order to facilitate understanding.

The heat exchanger 2 is of the air/oil type, configured to be mounted in an annular air stream of an axial turbomachine. Preferably, the axial turbomachine is a three-flow turbomachine, and the annular air stream is preferably an annular tertiary flow stream.

With reference to FIG. 1, the exchanger 2 comprises a heat exchange zone 3 having oil passages 4 and heat exchange surfaces 6 forming a heat exchange passage for the air flow F.

Preferably, the exchanger 2 is a one-piece part obtained by additive manufacturing, and more preferably obtained by laser fusion on a bed of aluminum powder. For this purpose, the oil passages 4 are formed by tubular channels allowing the circulation of oil and the exchange surfaces 6 are preferably formed by thin walls or plates, and advantageously, each plate delimits two surfaces of exchange 6.

The heat exchange zone 3 is radially delimited by an upper wall 12 and by a lower wall 9, the oil passages extend radially and axially between said upper wall 12 and lower wall 9.

Indeed, the heat exchanger 2 of the present invention is of the “ACOC” type, acronym for the English expression “Air-Cooled Oil Cooler”, the latter is different from a surface air-oil exchanger “SACOC”, in which the oil remains in the lower and upper walls and does not pass radially through the exchanger.

Advantageously, the heat exchange zone 3 has a profile facing the air flow and included in a plane perpendicular to said air flow, said profile of the heat exchange zone 3 being in an arc of a circle allowing the exchanger 2 to be able to be placed in the annular air stream, in particular thanks to a wall 8 of the exchanger 2, called the interior wall 8 and which is located radially inside the heat exchange zone 3, of so as to form a radially internal guide wall 8 of the annular air stream.

The interior wall 8 makes it possible to form a by-pass passage for the air 10 which is parallel to the heat exchange passage between the interior wall 8 and the heat exchange zone 3.

In this configuration, the exchanger 2 comprises an outer wall 12 radially and adjacent to the heat exchange zone 3, said outer wall 12 comprises at at least one upstream or downstream end a fixing flange 15 so as to be able to be fixed to an upstream or downstream casing of the annular air stream, the casing is preferably a casing external to the air flow F having the upstream and downstream parts fixed to the exchanger 2.

The air by-pass passage 10 is delimited radially by two radial limits having an arcuate profile and consisting of the interior wall 8 and a radial wall 9, the latter is the lower radial delimitation of the zone of heat exchange 3.

The air by-pass passage 10 is free of material between its two radial limits 8, 9 and/or its two lateral limits 11, one of which is not illustrated in FIG. 1 due to the cut made. The two lateral limits 11 are mainly perpendicular to the radial limits 8, 9, thus forming the air by-pass passage 10 having a cross section to the air flow F and which is rectangular curved following the arc of a circle profile.

The bypass passage for air 10 is commonly called air bypass 10, and can also be called “FOD” bypass, an acronym for the English expression “Foreign Object Debris”. Indeed, the air by-pass 10 extends longitudinally over a total extent of the exchanger 2, its main role is to allow the passage of debris contained in the air flow F through the annular vein of the turbomachine. Debris or “FOD” can for example be birds, hail, hailstones or any other object that can obstruct or damage the exchanger.

In parallel with the air by-pass 10, a protective grid can be placed on a front face of the exchanger 2 to further protect the oil passages 4 and the exchange surfaces 6, without hindering their capacity heat exchange.

The air by-pass 10 extends radially over a height h of between 10% and 20% of a cumulative radial height H of said by-pass passage and of the heat exchange zone.

Preferably, the height of the air by-pass 10 extends radially to a maximum of 15% of the cumulative radial height H.

The radial height h of the air by-pass 10 is constant over the total extent of the exchanger 2 following the air flow F. In fact, the height h does not change in any way following the flow of the air because it is not desired to modify the speed thereof, only the passage of debris is expected from the air by-pass 10. However, the height h can present a small variation of a maximum of 1% of the h value, which can be relative to the manufacturing precision.

Advantageously, the constancy of the height h makes it possible to limit the difference in pressure losses between the air by-pass 10 and the heat exchange zone 3. However, the radial height h of the air by-pass 10 can slightly vary in order to compensate for possible pressure losses which may be caused by aerodynamic disturbances downstream of the exchanger 2. In this regard, the air by-pass 10 may have a converging and/or divergent longitudinal section.

According to the first embodiment illustrated in FIG. 1, the heat exchange zone 3 is radially delimited by a radially internal face 14 belonging to the radial wall 9, and a radially external face 16 belonging to the external wall 12.

Preferably, the exchanger 2 includes an oil inlet and an oil outlet on the radially internal face 14.

The oil passages 4 comprise several paths between an oil inlet and an oil outlet, said paths extending radially externally to the radially internal face 14, and which are distributed along the arcuate profile. of heat exchange zone 3.

The heat exchange zone 3 may include a circumferential divergence in its downstream part, i.e. the circumferential section of the heat exchange zone 3 increases from upstream to downstream, allowing the oil passages 4 to be distributed circumferentially in the exchanger 2 between the oil inlet and the oil outlet while avoiding crossing the air by-pass.

FIG. 2 illustrates a sectional view of the exchanger 2 according to a second embodiment, schematically illustrating the oil paths.

Indeed, the second embodiment consists of positioning the air by-pass 10 in a radially high position so that said air by-pass 10 is adjacent to the external casing of the turbomachine. Whereas the first embodiment consists of positioning the air by-pass 10, having the same geometric configuration as described above, as being adjacent to an internal casing of the turbomachine.

In this regard, and with reference to FIG. 2, the exchanger 2 comprises an outer wall 12′ located radially outside the heat exchange zone 3, so as to form a radially outer guide wall of the vein annular air.

Similar to the outer wall 12 of FIG. 1, the outer wall 12′ of FIG. 2 can also include a fixing flange for fixing the exchanger to an external casing of the turbomachine.

In this configuration, the air by-pass 10 is delimited radially by two radial limits consisting of the outer wall 12′ and a radial wall 9′ delimiting radially externally the heat exchange zone 3. For this purpose, the radial height h of the air by-pass 10 is between the radial wall 9′ and the exterior wall 12.

The exchanger 2 further comprises an interior wall 8′, arranged radially internally and adjacent to the heat exchange zone 3. To this end, the interior wall 8′ comprises at at least one upstream or downstream or circumferential end, a fixing flange so as to be able to attach to an upstream or downstream casing of the annular air stream, said casing is preferably a casing internal to the air flow having the upstream and downstream parts fixed to the exchanger 2.

In this configuration, the exchanger 2 is configured to form an integral part of the internal and external casings of the turbomachine and to ensure aerodynamic continuity of the annular air stream.

Advantageously, the exchanger 2 can be manufactured and adapted according to the architecture of the turbomachine in which it will be mounted in order to anticipate the radial part of the annular air stream which includes the greatest risk of impact with debris. FOD″ so that the air by-pass 10 is arranged there.

FIG. 2 also illustrates the heat exchange zone 3 as being radially delimited by a radially internal face 14′ belonging to the interior wall 8′, and a radially external face 16′ belonging to the radial wall 9′.

Preferably, the exchanger 2 comprises an oil inlet 18 and an oil outlet 20 on the radially internal face 14′. However, the exchanger 2 can include the oil inlet and outlet 18, 20 on the radially outer face 16′.

The oil passages 4 comprise several paths 22 between the oil inlet 18 and the oil outlet 20 and which are distributed along the arcuate profile of the heat exchange zone 3. The exchanger 2 can include a single oil path or it can include several paths of up to 10 oil paths.

Each of the paths 22 comprises at least one forward portion 26 and at least one return portion 28, the terms “go” and “return” correspond to the direction of main radial flow of the oil in the oil passages 4. At this respect, the forward portion 26 corresponds to a portion of the oil path 22 in which the oil flows radially from bottom to top. Similarly, the return portion 28 corresponds to a portion of the oil path 22 in which the oil flows radially from top to bottom.

The two forward portions 26 and return 28 are offset along the profile in an arc of a circle of the heat exchange zone 3, and extend radially between the radially internal face 14′ and the radially external face 16′ of the heat exchange zone. In addition, each of the paths 22 comprises at least one connection portion 30 connecting the at least one forward portion 26 to the at least one return portion 28.

Advantageously, as can be seen in FIG. 2, the circumferential offset along the arcuate profile of the heat exchange zone 3 provided by the connection portion 30 between the forward portion 26 and the return portion 28 allows ‘increase circumferentially the path of the oil in the exchanger. For this purpose, the air flow is perpendicular to the path of the oil, and the heat exchange is maximized.

The radially internal face 14′ further comprises a distributor 32 disposed fluidically between the oil inlet 18 and the paths 22 and extending along the arcuate profile, and a collector 34 disposed fluidically between the paths 22 and the oil outlet 20 and extending along the arcuate profile.

The oil inlet 18 is at one end of the distributor 32 following the arcuate profile and having a passage section transverse to said arcuate profile which gradually decreases along the latter from the oil inlet 18 to an opposite end of the distributor 32.

Similarly, the oil outlet 20 is at one end of the collector 34 following the arcuate profile and having a passage section transverse to said arcuate profile which gradually decreases along the latter from the oil outlet 20 to an opposite end of collector 34.

Preferably, the distributor 32 and the collector 34 are side by side along an axial extent of the radially internal face 14′ of the heat exchange zone 3.

The present invention presents two different variations regarding the oil paths. The third and fourth embodiments which will be described concern variants of the oil path, it being understood that each of these third and fourth embodiments can apply either to the first mode or to the second mode. Indeed, we can choose a high or low radial position of the air by-pass and at the same time define the embodiment of the desired oil path.

FIG. 3 illustrates the oil paths 22 as described previously, in the exchanger according to the third embodiment, and in which, each of the forward 26, return 28 and connection 30 portions of each of the paths 22 extend over a total axial length of the heat exchange zone.

Each path 22 comprises several parallel oil passages 4 distributed over the total axial length of the heat exchange zone. More precisely, the oil passages 4 extend axially over the majority of the axial length of the heat exchange surfaces.

Preferably, the number of oil passages 4 is between 5 and 30 oil passages 4, and more preferably, between 10 and 25 oil passages 4.

FIG. 3a illustrates a bottom perspective view of the oil paths of FIG. 3 which are according to the third embodiment of the invention.

For this purpose, the distributor 32 makes it possible to supply the oil passages 4 which are included in the forward portions 26, and the connection between the distributor 32 and said forward portions 26 is made by means of an inlet passage d oil 33.

Preferably, each oil inlet passage 33 is an integral part of the oil passages 4, and comprises a passage section transverse to the air flow F and which gradually decreases along the latter.

Advantageously, reducing the cross section of the oil inlet passage 33 makes it possible to reduce pressure losses.

Similarly, the collector 34 makes it possible to recover the oil leaving the oil passages 4 which are included in the return portions 28 by means of an oil outlet passage 35.

FIG. 4 represents an oil path 22′ in the exchanger according to a fourth embodiment. Preferably, the exchanger comprises a plurality of oil paths similar to the oil path 22′.

The oil path 22′ comprises several oil passages 4′ which are formed by parallel tubular channels and forming a forward portion 26′ and a return portion 28′. Each of the forward 26′ and return 28′ portions forms an oil flow profile which is doubly bent with a first radial part 36, a second axial part 38 and a third radial part 40.

The exchanger according to the fourth embodiment can comprise a plurality of oil paths 22′. In this regard, each oil path 22′ can be directly linked to the distributor 32′ and the collector 34′ as well as to the oil inlet passages 33′ and to the oil outlet passages 35′ which are identical to those described previously for the third embodiment.

In the direction of the oil flow, i.e. from the oil inlet passage 33 to the oil outlet passage 35, the forward portions 26′ and the return portions 28′ are connected together via a portion of 30′ connection. Precisely, said connection portion 30′ makes it possible to connect two third radial parts 40, each belonging to the forward part 26′ and the other to the return part 28′.

Similarly and in the same direction of oil flow, the return parts 28′ are connected to the forward portions 26′ by means of the connection portion (not illustrated in FIG. 4). Precisely, said connection portion makes it possible to connect two first radial parts 36, each belonging to the return part 28′ and the other to the forward portion 26′.

FIG. 4 illustrates a single return portion 28′, however, each oil path 22′ may include several return portions 28′ and several forward portions 26′. Preferably, the oil path 22′ comprises two forward parts 26′ and two return parts 28′.

The second axial parts of the forward portions 26′ and return portions 28′ have opposite flow directions. For this purpose, the second axial part 38 of the return portion 28′ comprises the oil which is in a first axial flow direction opposite to the second axial part 38 of the forward portion 26′, the flow direction of the latter is particularly opposed to the air flow F.

In this configuration, the heat exchange between the oil passages 4′ and the air is partly carried out counter-currently. Advantageously, this allows a more efficient heat exchange by convection between the oil passages 4′ and the air flow F, this concretely makes it possible to minimize the length of the path of the oil in the oil passages 4′ of the exchanger, which makes it possible to reduce the size and weight of the exchanger in the turbomachine.

Preferably, the fourth embodiment of the invention is used in the case where the total axial extent of the heat exchange zone is greater than the total radial extent of the latter. Advantageously, this makes it possible to maximize the heat exchange in counter-current with the air flow.

The exchanger of the invention has a heat exchange zone being preferentially divergent in the radial direction and following the direction of the air flow.

Advantageously, the divergence of the heat exchange zone makes it possible to limit the pressure losses within the exchanger and to improve the heat exchange between the air and the oil passing through the oil passages 4′.

FIG. 5 illustrates a sectional view of the exchanger 2 according to the second embodiment, the exchanger 2 being arranged in the annular air stream.

The oil passages 4′ illustrated in FIG. 5 belong to the fourth embodiment of the invention. However, the divergence of the exchanger 2 is not limited to this last mode particularly, and the oil passages 4 illustrated in FIGS. 3 and 3a representing the third embodiment can also be used in FIG. 5.

With reference to FIG. 5, the total radial height Z of the heat exchange zone 3 increases from upstream to forward, and the axial air passage comprises air channels 5 delimited by the heat exchange surfaces 6 and having passage sections increasing from upstream to downstream in correspondence with the total radial height Z of the heat exchange zone 3.

The total radial height Z of the heat exchange zone 3 and/or the sections of the air channels 5 increase from upstream to downstream over at least 70% of a total axial extent of said heat exchange zone 3. Preferably, the sections of the air channels 5 increase from upstream to downstream over the entire total axial extent of the heat exchange zone 3.

The increase in the total radial height Z of the heat exchange zone 3 and/or the increase in the sections of the air channels 5 is monotonic and/or at least 30%.

Preferably, the increase in the sections of the air channels 5 is monotonous and at least 50%.

Preferably, the exchanger 2 comprises several angular sectors, each angular sector comprising the oil inlet 18 and the oil outlet, said oil inlet and/or said oil outlet is integrally formed in the interior wall, and at least one of the sectors comprises a short-circuiting passage (not illustrated) of said sector, also called oil by-pass, extending fluidly between the oil inlet 18 and the outlet of oil along the inside wall.

Advantageously, the oil by-pass ensures the cold operation of the exchanger 2, in particular at temperatures around −40° C., in fact, the cold oil has a high viscosity which is not suitable for allow its passage into exchanger 2, the oil therefore passes into the oil by-pass until it reaches a suitable viscosity.

In this regard, another circuit called the defrosting circuit (not shown) can be arranged near or in contact with the oil by-pass, and can also be in contact with the oil passages 4′, the defrosting circuit Defrosting can ensure the heating of the oil included in exchanger 2.

The oil by-pass comprises a normally closed valve capable of opening in the presence of a pressure difference between the oil inlet 18 and the oil outlet, greater than or equal to a limit value. The valve can also open when the viscosity of the oil is too high compared to a previously identified threshold.

FIG. 6 represents an enlarged portion A of the heat exchange zone identified in FIG. 2.

The enlarged portion A is slightly in perspective to facilitate its description and shows the oil passages 4 according to the third embodiment of the invention or the oil passages 4′ according to the fourth embodiment.

The air channels 5 are delimited by the exchange surfaces 6 and the forward portion 26, 26′ or the return portion 28, 28′. The sections of the air channels 5 have a polygonal and preferably pentagonal shape. More preferably, each air channel 5 is delimited by four plates having four exchange surfaces 6 and a forward portion 26, 26′ or a return portion 28, 28′ and two exchange surfaces 6 out of the four belonging to transverse plates integrally formed with the oil passages 4, 4′ of the forward portions 26, 26′ or the return portions 28, 28′.

For this purpose, the oil passages 4, 4′ can be formed by a recess of material in a plate or a panel, and the outward and return portions can be included in a radial panel.

The air channels 5 between each pair of forward portions 26, 26′ and neighboring return portions 28, 28′ form at least two radial rows 42, 44 of polygons, preferably pentagonal, nested. The number of radial rows 42, 44 may depend on the circumferential distance between the forward portion 26, 26′ and the return portion 28, 28′.

The heat exchange zone further comprises edge plates 7 presenting the exchange surfaces 6, in fact, the edge plates 7 are similar to the plates presenting the exchange surfaces 6 of the heat exchange zone.

Advantageously, the edge plates 7 make it possible to guarantee heat exchange at the edges of the heat exchange zone while generating a constant pressure loss relative to the rest of said heat exchange zone, this makes it possible to minimize the aerodynamic disturbances of the air flow in the annular vein.

The exchanger of the invention and according to any of the embodiments previously described, can extend continuously over 360° in a section of the annular air stream around the longitudinal axis of the turbomachine. Preferably, the exchanger extends discontinuously over 360° around the longitudinal axis, subdividing into several angular segments and each exchanger can provide a heat exchange function between the air and the oil which can be different. from one segment to another.

Indeed, each can combine the cooling of several functions or oil circuits of the turbomachine, and this depending on different parameters linked to the need for oil cooling, i.e. inlet temperatures, flow rates, requested outlet temperature or the air conditions, the different circuits can be placed in thermal contact or isolated.

In this regard, the exchanger can ensure the cooling of the oil used in several components of the aircraft, in particular, an engine, a gearbox, an engine generator and any electronic component requiring cooling.

Advantageously, the exchanger and in particular the oil passages can withstand a low oil temperature of up to −54° C., and at the same time withstand a high oil temperature of up to 180° C. with a flow rate reaching 30000 l/h.

It should be noted that the invention is not limited to the examples described in the figures. The teachings of the present invention may in particular be applicable to another type of turbomachine.

Each technical characteristic of each illustrated example is applicable to the other examples. In particular, the combination of the third or fourth embodiment with the first or second embodiment.

1.-18. (canceled)

19. A heat exchanger of the air/oil type, for an annular air stream of a turbomachine, comprising a heat exchange zone with oil passages and surfaces of heat exchange surfaces with air, said heat exchange zone forming an axial air passage and having a profile facing the air flow and included in a plane perpendicular to said flow of air, said profile of the heat exchange zone being in a form of an arc so as to be able to be arranged in the annular air stream,
wherein said heat exchanger comprises on a radially internal or external face of the heat exchange zone, an oil inlet and an oil outlet, the oil passages comprising several paths between said oil inlet and said oil outlet, distributed along the arcuate profile of the heat exchange zone, each of the paths comprising at least one forward portion and at least one return portion, extending radially between the radially internal face and the radially external face, and wherein the at least one forward portion and the at least one return portion of each of the paths are offset along the arcuate profile of the heat exchange zone.

20. The heat exchanger according to claim 19, wherein each of the paths comprises at least one connection portion connecting the at least one forward portion to the at least one return portion and arranged in the heat exchange zone.

21. The heat exchanger according to claim 19, wherein each of the at least one forward portion, the at least one return portion, and the at least one connection portion of each of the paths extend over a total axial length of the heat exchange zone.

22. The heat exchanger according to claim 21, wherein each of the paths comprises several parallel oil passages distributed over the total axial length of the heat exchange zone.

23. The heat exchanger according to claim 19, wherein the at least one forward portion and the at least one return portion of each of the paths comprises several oil passages parallel forming a doubly bent flow profile with a first radial part, a second axial part and a third radial part.

24. The heat exchanger according to claim 23, wherein the at least one connection portion interconnects the first radial part or the third radial part adjacent to said connection portion.

25. The heat exchanger according to claim 24, wherein the second axial parts of the at least one forward portion and the at least one return portion have opposite flow directions.

26. The heat exchanger according to claim 19, comprising on the radially internal face or the radially external face of the heat exchange zone comprising the oil inlet and the oil outlet, in addition, a distributor arranged fluidically between the oil inlet and the paths and extending along the arcuate profile, and a collector fluidly disposed between the paths and the oil outlet and extending along the arcuate arc profile.

27. The heat exchanger according to claim 26, wherein the oil inlet is at one end of the distributor following the arcuate profile and said distributor has a passage section transverse to said arcuate profile which gradually decreases along said arcuate profile from the oil inlet to an opposite end of said distributor.

28. The heat exchanger according to claim 27, wherein the oil outlet is at one end of the collector following the arcuate profile and said collector has a passage section transverse to said arcuate profile which gradually decreases along said arcuate profile from the oil outlet to an opposite end of said collector.

29. The heat exchanger according to claim 28, wherein the distributor and the collector are side by side along an axial extent of the radially internal face or external of the heat exchange zone comprising the oil inlet and the oil outlet.

30. The heat exchanger according to claim 19, wherein the total radial height of the heat exchange zone increases from upstream to forward, and the air passage axial comprises air channels delimited by the heat exchange surfaces and having passage sections increasing from upstream to downstream in correspondence with the total radial height of the heat exchange zone.

31. The heat exchanger according to claim 30, wherein the total radial height of the heat exchange zone and/or the sections of the air channels increases from upstream to downstream over at least 70% of a total axial extent of said heat exchange zone.

32. The heat exchanger according to claim 31, wherein the increase in the total radial height of the heat exchange zone and/or the increase in the sections of the air channels is monotonic and/or at least 30%.

33. The heat exchanger according to claim 32, wherein the sections of the air channels have a polygonal shape.

34. The heat exchanger according to claim 19, wherein the heat exchange zone comprises the forward portions and the return portions extending radially and distributed along the arcuate profile, and comprising the heat exchange surfaces being formed by transverse walls extending between the forward portions and/or the return portions.

35. The heat exchanger according to claim 19, wherein the air channels between each pair of neighboring forward portions and return portions form at least two radial rows of nested polygons.

36. The heat exchanger according to claim 19, wherein the transverse walls are integrally formed with the forward portions or with the return portions.
